(19) United States
(12) Patent Application Publication
(10) Pub. No.: US 2026/0138924 A1
(43) Pub. Date: May 21, 2026

(54) CERAMIC STRUCTURE COMPOSITIONS AND METHODS FOR MAKING THE SAME FROM ALGAL BIOMASS

(71) Applicant: Georgia Southern University Research and Service Foundation, Inc., Statesboro, GA (US)

(72) Inventors: Casey Schachner, Statesboro, GA (US); Jennifer Zettler, Statesboro, GA (US)

(21) Appl. No.: 19/396,929

(22) Filed: Nov. 21, 2025

Related U.S. Application Data
(60) Provisional application No. 63/723,259, filed on Nov. 21, 2024.

(51) Int. Cl. C04B 33/132; C04B 33/30; C04B 33/32; C04B 41/00; C04B 41/80

(52) U.S. Cl. CPC C04B 33/132; C04B 33/30; C04B 33/32; C04B 41/0072; C04B 41/009; C04B 41/80; C04B 2235/349; C04B 2235/606; C04B 2235/65

(57) ABSTRACT

The present disclosure provides for a method of making a clay comprising obtaining algal biomass and processing the algal biomass and a method of making a ceramic and a method of reef restoration relating thereto. Also provided herein is a ceramic composition comprising ash, wherein the ash comprises silica and calcium, potassium, magnesium, phosphorous, nitrogen, or sulfur, or any combination thereof, wherein the ceramic composition is porous and has a reduced solubility in water.

### CROSS-REFERENCE TO RELATED APPLICATIONS

This application claims the benefit of U.S. Provisional Application No. 63/723,259, filed Nov. 21, 2024, the contents of which are incorporated herein by reference in entirety.

### FIELD OF THE INVENTION

The invention is in the area of methods of making a clay comprising obtaining algal biomass and processing the algal biomass and methods of making a ceramic and methods of reef restoration. Also provided herein are ceramic compositions comprising ash, wherein the ash comprises silica and calcium, potassium, magnesium, phosphorous, nitrogen, or sulfur, or any combination thereof.

### BACKGROUND OF THE INVENTION

The United States is a key global exporter of kaolin clay mined in Georgia; however, these finite mineral deposits that formed millions of years ago will eventually be exhausted. In addition, the industrial processes used to harvest these mined minerals are taxing on the environment and landscape restoration is a costly endeavor. Other common sources of clay are exclusively mined from regions experiencing war and other conflicts that can affect global supplies and create widespread shortages.

As the non-renewable products of clay mines become exhausted, innovative and comparatively less environmentally harmful alternative sources are urgently needed.

### SUMMARY OF THE INVENTION

In accordance with the purposes of the disclosed materials and methods, as embodied and broadly described herein, the disclosed subject matter, in one aspect, relates to algal biomass and methods and compositions thereof.

Thus, in one example, a method of making a clay is provided, including obtaining algal biomass and processing the algal biomass.

In a further example, a method of making a ceramic is provided, including the method disclosed herein and heating the clay at a temperature between about 1100° F. to about 2700° F.

Additionally, a method of reef restoration is provided, including making a sculpture suitable for reef restoration according to the method disclosed herein, and placing the sculpture in a body of water.

In one example, a ceramic composition is provided, including ash, wherein the ash comprises silica and calcium, potassium, magnesium, phosphorous, nitrogen, or sulfur, or any combination thereof, wherein the ceramic composition is porous and has a reduced solubility in water.

In one aspect, provided herein is a method of making a clay comprising: (i) obtaining algal biomass; and (ii) processing the algal biomass.

In some embodiments, the processing the algal biomass comprises filtering the algal biomass, removing a particulate from the algal biomass, homogenizing one or more particulates from the algal biomass, powderizing the algal biomass, or any combination thereof.

In some embodiments, the method further comprises combining the dried algal biomass with a water mixture.

In some embodiments, the method further comprises shaping the algal biomass into a clay body.

In one aspect, provided herein is a method of making a ceramic, comprising: (i) obtaining algal biomass; (ii) processing the algal biomass; (iii) shaping the algal biomass to provide a clay body; and (iv) heating the clay body at a temperature between about 1100° F. to about 2700° F.

In some embodiments, the clay body is heated at a temperature between about 1700° F. to about 2100° F. In some embodiments, the clay body is heated at a temperature between about 2100° F. to about 2300° F. In some embodiments, the clay body is heated at a temperature between about 2300° F. to about 2700° F.

In some embodiments, the clay body is heated until it is porous and has a reduced solubility in water.

In one aspect, provided herein is a method of reef restoration, comprising: (i) obtaining algal biomass; (ii) processing the algal biomass; (iii) shaping the algal biomass to provide a clay body; (iv) heating the clay body at a temperature between about 1100° F. to about 2700° F. to provide a ceramic sculpture; and (v) placing the ceramic sculpture in a body of water.

In one aspect, provided herein is a ceramic composition, comprising ash derived from algal biomass, wherein the ash comprises silica, wherein the ceramic composition is porous, and wherein the ceramic composition has a reduced solubility in water relative to the clay body prior to heating.

In some embodiments, the ceramic composition comprises between about 50% to about 90% ash by weight of total dried algal biomass.

In some embodiments, the ceramic composition between about 25% to about 75% silica by weight of total ash.

In some embodiments, the ceramic composition further comprises calcium, potassium, magnesium, phosphorous, nitrogen, or sulfur, or any combination thereof.

In some embodiments, the percent composition of calcium in obtained algal biomass by weight is between about 1.1% to about 1.3%; wherein the percent composition of potassium in obtained algal biomass by weight is between about 0.5% to about 0.7%; wherein the percent composition of magnesium in obtained algal biomass by weight is between about 0.9% to about 1.1%; wherein the percent composition of phosphorous in obtained algal biomass by weight is between about 0.05% to about 0.15%; wherein the percent composition of nitrogen in obtained algal biomass by weight is between about 0.3% to about 0.5%; and/or wherein the percent composition of sulfur in obtained algal biomass by weight is between about 1.0% to about 1.2%.

In some embodiments, the ceramic composition further comprises aluminum, boron, cadmium, chromium, cooper, iron, manganese, sodium, nickel, lead, or zinc, or any combination thereof.

In some embodiments, the ceramic composition comprises between about 32000 ppm to about 43000 ppm of aluminum; wherein the ceramic composition comprises between about 64 ppm to about 82 ppm of boron; wherein the ceramic composition comprises between about 1.1 ppm to about 1.5 ppm of cadmium; wherein the ceramic composition comprises between about 50 ppm to about 60 ppm of chromium; wherein the ceramic composition comprises between about 12.5 ppm to about 13.7 ppm of copper; wherein the ceramic composition comprises between about 27850 ppm to about 30500 ppm of iron; wherein the ceramic composition comprises between about 830 ppm to about 870 ppm of manganese; wherein the ceramic composition comprises between about 30000 ppm to about 40000 ppm of sodium; wherein the ceramic composition comprises between about 13 ppm to about 15.5 ppm of nickel; wherein the ceramic composition comprises between about 37.5 ppm to about 47.5 ppm of lead; and/or wherein the ceramic composition comprises between about 74 ppm to about 90 ppm of zinc.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying figures, which are incorporated in and constitute a part of this specification, illustrate several aspects described below.

FIG. 1 shows an example growth of algae on the flow-ways of an algal turf scrubber (ATS) system operation.

FIG. 2 shows example hand-sculpted horseshoe crabs using clay made from algal biomass. These example clay figures have not dried and are still pliable.

FIGS. 3A-3B show unprocessed raw algal biomass in the form of clay slip poured in silicone molds (FIG. 3A) ready to air dry, and the resulting ceramic tiles (FIG. 3B) kiln-fired to a bisque temperature around 1830° F./999° C. Remnants of mollusk and barnacle shells appear as white specks in the finished red ceramic tiles.

FIGS. 4A-4D show algal biomass scraped from the surface of a concrete boat-ramp was dried and then broken into smaller fragments (FIG. 4A), ground in a blender (FIG. 4B), turned into a fine powder (FIG. 4C) and then rehydrated to form a moldable clay (FIG. 4D).

FIG. 5 shows hand sculpted horseshoe crabs using clay made from algal biomass. The closest crab figure (i) is air dried (greenware) and the other three crab figures (ii), (iii), and (iv) are bisque fired 1830° F./999° C. (cone 06). The closest of the other three, fired crab figure (ii), was made from clay scraped from the side of a marine tank, while the next fired crab figure (iii) was from algae from an ATS system, and the last fired crab figure (iv) was crafted from clay made from algae growing a concrete boat ramp. Notice that for the ceramic fired crab figure (ii) from the marine tank, the evaporated salts and calcium particulates surfaced in the firing process giving the sculpture a mottled appearance.

FIG. 6 shows ceramic test tiles crafted from ATS algae displaying the range of firing temperatures from raw greenware (top) to bisque 1830° F./999° C. (cone 06) to glaze 2280° F./1249° C. (cone 10).

FIG. 7 shows a horseshoe crab shell (left) was used to create a plaster mold to create an algae-Lizella clay ceramic press (right) that was bisque fired to 1830° F./999° C.

FIG. 8 shows a kaolin mine in Georgia.

FIGS. 9A-9B shows reef restoration pieces, wherein oyster larvae also known as spar are growing on the surface of the algal ceramics (FIG. 9A), with a detail image of the oyster spat growing on an example piece (FIG. 9B).

FIGS. 10A-10B show a sculpture made of algal waste and ceramic submerged in an aquarium tank (FIG. 10A) and a seahorse and pipefish interacting with an algae ceramic piece (FIG. 10B).

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a composition”, or “a disorder”, includes, but is not limited to, two or more such compounds, compositions, or disorders, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise. As used herein, the term “substantially free,” when used in the context of a composition or component of a composition that is substantially absent, is intended to refer to an amount that is then about 1% by weight or less, e.g., less than about 0.5% by weight, less than about 0.1% by weight, less than about 0.05% by weight, or less than about 0.01% by weight of the stated material, based on the total weight of the composition.

### Methods

### Methods of Making a Clay

In one aspect, provided herein is a method of making a clay, comprising: (i) obtaining algal biomass; (ii) shaping the algal biomass to provide a clay body. In some embodiments, the algal biomass is shaped using a mold. In some embodiments, the mold comprises a plaster mold or a silicone mold. In some embodiments, the method further comprises processing the algal biomass of step (i) to remove one or more particulates.

As used herein, the term “clay body” refers to a processed and/or shaped algal biomass that is capable of being heated to form a ceramic as described herein.

In one aspect, provided herein is a method of making a clay, comprising (i) obtaining algal biomass; and (ii) processing the algal biomass. In some embodiments, the method further comprises shaping the processed algal biomass of step (ii) to provide a clay body.

In one aspect, provided herein is a method of making a clay, comprising (i) obtaining algal biomass; (ii) processing the algal biomass; and (iii) shaping the processed algal biomass to provide a clay body. In some embodiments, the processed algal biomass is shaped using a mold. In some embodiments, the mold comprises a plaster mold or a silicone mold.

In one aspect, provided herein is a method of making a clay, comprising (i) obtaining algal biomass; (ii) processing the algal biomass; (iii) shaping the processed algal biomass to provide a clay body. In some embodiments, the processed algal biomass is shaped using a mold. In some embodiments, the mold comprises a plaster mold or a silicone mold.

As used herein, “algal biomass” refers to aquatic material derived from chlorophyll-equipped photosynthetic microorganisms. In some embodiments, the chlorophyll-equipped photosynthetic microorganisms comprise periphyton. In some embodiments, the algal biomass comprises a diatom, a cyanobacterium, a green algae, or a combination thereof. In some embodiments, the algal biomass is derived from an algal bloom. In some embodiments, the algal biomass is obtained from a marine waterway or a brackish waterway.

In some embodiments, the algal biomass is obtained by a periphyton nutrient removal system. In some embodiments, the algal biomass is obtained by an algal turf scrubber (ATS) system. ATS systems are designed to remediate polluted waters where wastewater and agricultural runoff have caused eutrophication, and the non-point source of excess nutrients cannot be determined. These ATS systems improve water quality by encouraging algal growth on flow-way surfaces rather than forming harmful blooms in open waters. Excessive nutrients from the water accumulate in the flow-way's lawn of algae. In some embodiments, the ATS system is a small-scale ATS system. In some embodiments, the ATS system is a large-scale ATS system.

In some embodiments, the algal biomass is obtained from one or more surfaces of an object submerged in a marine waterway or a brackish waterway. In some embodiments, the algal biomass is obtained from one or more surfaces of a tank, a boat, a boat ramp, or any combination thereof, submerged in a marine waterway or a brackish waterway.

In some embodiments, prior to processing the algal biomass, one or more abrasive barnacles and/or one or more mollusk shells are removed. In some embodiments, prior to processing the algal biomass, the algal biomass is frozen. In some embodiments, immediately prior to processing the algal biomass, the algal biomass is defrosted.

In some embodiments, processing the algal biomass comprises filtering the algal biomass. In further embodiments, filtering the algal biomass comprises pushing the algal biomass through a mesh layer. In further embodiments, the mesh layer comprises a metal screen or cheesecloth. In some embodiments, the metal screen comprises a metal screen colander.

In some embodiments, processing the algal biomass comprises removing one or more particulates from the algal biomass. In some embodiments, processing the algal biomass comprises homogenizing one or more particulates from the algal biomass. In some embodiments, the one or more particulates comprise shells. In some embodiments, the one or more particulates comprise one or more abrasive barnacles and/or one or more mollusk shells.

The term “homogenizing” as used herein refers to the process of changing the average particulate size of any composition described herein such that all particulates in the composition are similar in size.

In some embodiments, processing the algal biomass further comprises powderizing the algal biomass, wherein powderizing the algal biomass comprises drying the algal biomass to result in dried algal biomass and grinding the dried algal biomass. In some embodiments, grinding the algal biomass comprises grinding the algal biomass with a mortar and pestle, a blender, or a combination thereof.

In some embodiments, drying the algal biomass comprises air drying the algal biomass, heating the algal biomass, or any combination thereof. In some embodiments, the algal biomass is heated in an oven.

In some embodiments, the oven is at a temperature between about 90° C. to about 120° C. In some embodiments, the oven is at a temperature between about 90° C. to about 100° C., about 100° C. to about 110° C., or about 110° C. to about 120° C. In some embodiments, the oven is at a temperature between about 90° C. to about 110° C.

In some embodiments, the algal biomass is heated for about 68 hours to about 76 hours. In some embodiments, the algal biomass is heated for about 68 to about 70 hours, about 70 to about 72 hours, about 72 to about 74 hours, or about 74 to about 76 hours. In some embodiments, the algal biomass is heated for about 68 to about 72 hours or about 68 to about 74 hours.

In one aspect, provided herein is a method of making a clay, comprising (i) obtaining algal biomass; (ii) filtering the algal biomass; (iii) homogenizing one or more particulates from the filtered algal biomass; and (iv) shaping the homogenized algal biomass to provide a clay body. In some embodiments, the algal biomass is shaped using a mold. In some embodiments, the mold comprises a plaster mold or a silicone mold. In some embodiments, the one or more particulates comprise shells. In some embodiments, the one or more particulates comprise one or more abrasive barnacles and/or one or more mollusk shells.

In one aspect, provided herein is a method of making a clay, comprising (i) obtaining algal biomass; (ii) filtering the algal biomass; (iii) powderizing the filtered algal biomass; (iv) rehydrating the powderized algal biomass; and (v) shaping the rehydrated algal biomass to provide a clay body. In some embodiments, powderizing the algal biomass comprises drying the filtered algal biomass to provide a dried, filtered algal biomass, and grinding the dried, filtered algal biomass. In some embodiments, grinding the algal biomass comprises grinding the algal biomass with a mortar and pestle, a blender, or a combination thereof. In some embodiments, the processed algal biomass is shaped using a mold. In some embodiments, the mold comprises a plaster mold or a silicone mold.

In some embodiments, the method further comprises rehydrating the dried algal biomass with a water mixture.

In some embodiments, the method further comprises mixing the clay body with one or more non-algal biomass derived clay materials. In some embodiments, the clay body and one or more non-algal biomass derived clay materials are mixed in equal amounts. In some embodiments, the clay body and one or more non-algal biomass derived clay materials are mixed in unequal amounts. In some embodiments, the method further comprises mixing the clay body with one or more dyes and/or pigment stains.

### Methods of Making a Ceramic

Also provided herein is a method of making a ceramic comprising a method for making a clay of any preceding aspect, further comprising the step of heating the clay body at a temperature between about 1100° F. to about 2700° F.

The term “ceramic” as used herein refers to a material that is neither metallic nor organic. In some embodiments, a ceramic is crystalline, glassy or both crystalline and glassy. In some embodiments, ceramics are hard and chemically non-reactive and can be formed or densified with heat. In some embodiments, the ceramic comprises a porcelain, a pottery, a stoneware, an earthenware, dinnerware, cookware, or a brick.

In some embodiments, the clay body is heated using a kiln, a pit firing, a barrel firing, or a combination thereof. In some embodiments, the kiln comprises an electric kiln. In some embodiments, the kiln comprises an electric oxidizing kiln.

In some embodiments, the clay body is heated at a temperature between about 1700° F. to about 2100° F. In some embodiments, the clay body is heated at a temperature between about 1700° F. to about 1725° F., about 1725° F. to about 1750° F., about 1750° F. to about 1775° F., about 1775° F. to about 1800° F., about 1800° F. to about 1825° F., about 1825° F. to about 1850° F., about 1850° F. to about 1875° F., about 1875° F. to about 1900° F., about 1900° F. to about 1925° F., about 1925° F. to about 1950° F., about 1950° F. to about 1975° F., about 1975° F. to about 2000° F., about 2000° F. to about 2025° F., about 2025° F. to about 2050° F., about 2050° F. to about 2075° F., or about 2075° F. to about 2100° F. In some embodiments, the clay body is heated at a temperature between about 1700° F. to about 1750° F., about 1750° F. to about 1800° F., about 1800° F. to about 1850° F., about 1850° F. to about 1900° F., about 1900° F. to about 1950° F., about 1950° F. to about 2000° F., about 2000° F. to about 2050° F., or about 2050° F. to about 2100° F. In some embodiments, the clay body is heated at a temperature between about 1700° F. to about 1800° F., about 1800° F. to about 1900° F., about 1900° F. to about 2000° F., about 2000° F. to about 2100° F. In some examples, the clay body is heated at from about 1700° F. to about 1725° F., about 1700° F. to about 1750° F., about 1700° F. to about 1775° F., about 1700° F. to about 1800° F., about 1700° F. to about 1825° F., about 1700° F. to about 1850° F., about 1700° F. to about 1875° F., about 1700° F. to about 1900° F., about 1700° F. to about 1925° F., about 1700° F. to about 1950° F., about 1700° F. to about 1975° F., about 1700° F. to about 2000° F., about 1700° F. to about 2025° F., about 1700° F. to about 2050° F., about 1700° F. to about 2075° F., or about 1700° F. to about 2100° F.

Clay fired at temperatures between about 1700° F. to about 2100° F. is considered low-fire and is usually known for its bright, colorful glazes.

In some embodiments, the clay body is heated at a temperature between about 2100° F. to about 2300° F. In some embodiments, the clay body is heated at a temperature between about 2100° F. to about 2125° F., about 2125° F. to about 2150° F., about 2150° F. to about 2175° F., about 2175° F. to about 2200° F., about 2200° F. to about 2225° F., about 2225° F. to about 2250° F., about 2250° F. to about 2275° F., about 2275° F. to about 2300° F. In some embodiments, the clay body is heated at a temperature between about 2100° F. to about 2110° F., about 2110° F. to about 2120° F., about 2120° F. to about 2130° F., about 2130° F. to about 2140° F., about 2140° F. to about 2150° F., about 2150° F. to about 2160° F., about 2160° F. to about 2170° F., about 2170° F. to 2180° F., about 2180° F. to about 2190° F., about 2190° F. to about 2200° F., about 2200° F. to about 2210° F., about 2210° F. to about 2220° F., about 2220° F. to about 2230° F., about 2230° F. to about 2240° F., about 2240° F. to about 2250° F., about 2250° F. to about 2260° F., about 2260° F. to about 2270° F., about 2270° F. to about 2280° F., about 2280° F. to about 2290° F., or about 2290° F. to about 2300° F. In some embodiments, the clay body is heated at a temperature between about 2100° F. to about 2110° F., about 2100° F. to about 2120° F., about 2100° F. to about 2130° F., about 2100° F. to about 2140° F., about 2100° F. to about 2150° F., about 2100° F. to about 2160° F., about 2100° F. to about 2170° F., about 2100° F. to about 2180° F., about 2100° F. to about 2190° F., about 2100° F. to about 2200° F., about 2100° F. to about 2210° F., about 2100° F. to about 2220° F., about 2100° F. to about 2230° F., about 2100° F. to about 2240° F., about 2100° F. to about 2250° F., about 2100° F. to about 2260° F., about 2100° F. to 2270° F., about 2100° F. to 2280° F., about 2100° F. to about 2290° F., or about 2100° F. to about 2300° F. In some embodiments, the clay is heated at a temperature between about 2100° F. to about 2125° F., about 2100° F. to about 2150° F., about 2100° F. to about 2175° F., about 2100° F. to about 2200° F., about 2100° F. to about 2225° F., about 2100° F. to about 2250° F., about 2100° F. to about 2275° F., or about 2100° F. to about 2300° F.

Clay fired at temperatures of between about 2100° F. to about 2300° F. is considered mid-range and in some examples, is relatively soft and porous after firing, but the firing process usually makes it more durable.

In some embodiments, the clay body is heated at a temperature between about 2300° F. to about 2700° F. In some embodiments, the clay body is heated at a temperature between about 2300° F. to about 2325° F., about 2300° F. to about 2350° F., about 2300° F. to about 2375° F., about 2300° F. to about 2400° F., about 2300° F. to about 2425° F., about 2300° F. to about 2450° F., about 2300° F. to about 2475° F., about 2300° F. to about 2500° F., about 2300° F. to about 2525° F., about 2300° F. to about 2550° F., about 2300° F. to about 2575° F., about 2300° F. to about 2600° F., about 2300° F. to about 2625° F., about 2300° F. to about 2650° F., about 2300° F. to about 2675° F., or about 2300° F. to about 2700° F. In some embodiments, the clay body is heated at a temperature between about 2300° F. to about 2350° F., about 2350° F. to about 2400° F., about 2400° F. to about 2450° F., about 2450° F. to about 2500° F., about 2500° F. to about 2550° F., about 2550° F. to about 2600° F., about 2600° F. to about 2650° F., or about 2650° F. to about 2700° F. In some embodiments, the clay body is heated at a temperature between about 2300° F. to about 2400° F., about 2400° F. to about 2500° F., about 2500° F. to about 2600° F., or about 2600° F. to about 2700° F. In some embodiments, the clay body is heated at a temperature between about 2300° F. to about 2325° F., about 2325° F. to about 2350° F., about 2350° F. to about 2375° F., about 2375° F. to about 2400° F., about 2400° F. to about 2425° F., about 2425° F. to about 2450° F., about 2450° F. to about 2475° F., about 2475° F. to about 2500° F., about 2500° F. to about 2525° F., about 2525° F. to about 2550° F., about 2550° F. to about 2575° F., about 2575° F. to about 2600° F., about 2600° F. to about 2625° F., about 2625° F. to about 2650° F., about 2650° F. to about 2675° F., or about 2675° F. to about 2700° F.

Clay fired at temperatures of between about 2300° F. to about 2700° F. is considered high-fire and after firing, in some examples, results in pottery that is strong, vitrified, and less porous. In some embodiments, clay fired at this temperature can be used for utility items such as dinnerware and cookware.

In some embodiments, the clay body is heated at a temperature of about 1830° F. In some embodiments, the clay body is heated at a temperature between about 1800° F. to about 1810° F., about 1800° F. to about 1820° F., about 1800° F. to about 1830° F., about 1800° F. to about 1840° F., about 1800° F. to about 1850° F., about 1800° F. to about 1860° F., about 1800° F. to about 1870° F., about 1800° F. to about 1880° F., about 1800° F. to about 1890° F., or about 1800° F. to about 1900° F. In some embodiments, the clay body is heated at a temperature between about 1800° F. to about 1810° F., about 1810° F. to about 1820° F., about 1820° F. to about 1830° F., about 1830° F. to about 1840° F., about 1840° F. to about 1850° F., about 1850° F. to about 1860° F., about 1860° F. to about 1870° F., about 1870° F. to about 1880° F., about 1880° F. to about 1890° F., or about 1890° F. to about 1900° F. In some embodiments, the clay body is heated at a temperature between about 1820° F. to about 1821° F., about 1821° F. to about 1822° F., about 1822° F. to about 1823° F., about 1823° F. to about 1824° F., about 1824° F. to about 1825° F., about 1825° F. to about 1826° F., about 1826° F. to about 1827° F., about 1827° F. to about 1828° F., about 1828° F. to about 1829° F., about 1829° F. to about 1830° F., about 1830° F. to about 1831° F., about 1831° F. to about 1832° F., about 1832° F. to about 1833° F., about 1833° F. to about 1834° F., about 1834° F. to about 1835° F., about 1835° F. to about 1836° F., about 1836° F. to about 1837° F., about 1837° F. to about 1838° F., about 1838° F. to about 1839° F., about 1839° F. to about 1840° F. In some embodiments, the clay body is heated at a temperature between about 1820° F. to about 1821° F., about 1820° F. to about 1822° F., about 1820° F. to about 1823° F., about 1820° F. to about 1824° F., about 1820° F. to about 1825° F., about 1820° F. to about 1826° F., about 1820° F. to about 1827° F., about 1820° F. to about 1828° F., about 1820° F. to about 1829° F., about 1820° F. to about 1830° F., about 1820° F. to about 1831° F., about 1820° F. to about 1832° F., about 1820° F. to about 1833° F., about 1820° F. to about 1834° F., about 1820° F. to about 1835° F., about 1820° F. to about 1836° F., about 1820° F. to about 1837° F., about 1820° F. to about 1838° F., about 1820° F. to about 1839° F., or about 1820° F. to about 1840° F.

In some embodiments, the clay body is heated at a temperature of about 2280° F. In some embodiments, the clay body is heated at a temperature between about 2250° F. to about 2260° F., about 2260° F. to about 2270° F., about 2270° F. to about 2280° F., about 2280° F. to about 2290° F., about 2290° F. to about 2300° F., about 2300° F. to about 2310° F., about 2310° F. to about 2320° F., about 2320° F. to about 2330° F., about 2330° F. to about 2340° F., or about 2340° F. to about 2350° F. In some embodiments, the clay body is heated at a temperature between about 2250° F. to about 2260° F., about 2250° F. to about 2270° F., about 2250° F. to about 2280° F., about 2250° F. to about 2290° F., about 2250° F. to about 2300° F., about 2250° F. to about 2310° F., about 2250° F. to about 2320° F., about 2250° F. to about 2330° F., about 2250° F. to about 2340° F., or about 2250° F. to about 2350° F. In some embodiments, the clay body is heated at a temperature between about 2270° F. to about 2271° F., about 2270° F. to about 2272° F., about 2270° F. to about 2273° F., about 2270° F. to about 2274° F., about 2270° F. to about 2275° F., about 2270° F. to about 2276° F., about 2270° F. to about 2277° F., about 2270° F. to about 2278° F., about 2270° F. to about 2279° F., about 2270° F. to about 2280° F., about 2270 to about 2281° F., about 2270° F. to about 2282° F., about 2270° F. to about 2283° F., about 2270° F. to about 2284° F., about 2270° F. to about 2285° F., about 2270° F. to about 2286° F., about 2270° F. to about 2287° F., about 2270° F. to about 2288° F., about 2270° F. to about 2289° F., or about 2270° F. to about 2290° F. In some embodiments, the clay body is heated at a temperature between about 2270° F. to about 2271° F., about 2271° F. to about 2272° F., about 2272° F. to about 2273° F., about 2273° F. to about 2274° F., about 2274° F. to about 2275° F., about 2275° F. to about 2276° F., about 2276° F. to about 2277° F., about 2277° F. to about 2278° F., about 2278° F. to about 2279° F., about 2279° F. to about 2280° F., about 2280° F. to about 2281° F., about 2281° F. to about 2282° F., about 2282° F. to about 2283° F., about 2283° F. to about 2284° F., about 2284° F. to about 2285° F., about 2285° F. to about 2286° F., about 2286° F. to about 2287° F., about 2287° F. to about 2288° F., about 2288° F. to about 2289° F., or about 2289° F. to about 2290° F.

In some embodiments, the method further comprises re-hydrating the clay body and shaping the re-hydrating the clay body into a desired shape prior to heating. In some embodiments, the clay body comprises greenware.

In some embodiments, the clay body is heated until it is porous and has a reduced solubility in water as compared to prior to heating.

### Method of Reef Restoration

In one aspect, provided herein is a method of reef restoration comprising making a sculpture suitable for reef restoration according to a method of any preceding aspect disclosed herein, and placing the sculpture in a body of water.

The term “reef restoration” as used herein refers to methods of rebuilding damaged coral reefs. Existing methods of reef restoration include, but are not limited to, coral gardening, coral IVF, and coral aquaculture and deployment, for example.

In one aspect, provided herein is a method of reef restoration, comprising: (i) obtaining algal biomass; (ii) processing the algal biomass; (iii) shaping the algal biomass to provide a clay body; (iv) heating the clay body at a temperature between about 1100° F. to about 2700° F. to provide a ceramic sculpture; and (v) placing the ceramic sculpture in a body of water.

In some embodiments, a body of water includes a body of salt water, such as an ocean, sea, bay, gulf, or salt lake.

In some embodiments, the sculpture suitable for reef restoration comprises a three-dimensional (3D) frame, a 3D star, a pyramid, a cube, or a sphere.

### Compositions

### Ceramic Compositions

In one aspect, provided herein is a ceramic composition comprising ash, wherein the ash comprises silica and is derived from algal biomass and wherein the ceramic composition is porous and has a reduced solubility in water. In some embodiments, the silica is derived from one or more diatoms in the algal biomass.

Silica is a chemical compound composed of silicon and oxygen with the chemical formula SiO₂, or silicon dioxide. In some embodiments, silica is in a crystalline form, also known as a polymorph.

As used herein, the term “ash” refers to the mineral residue remaining as organic matter burns away, with the exact composition varying depending on the source material, such as wood, coal, or biomass. In some embodiments, the ash contains negligible organic matter. In some embodiments, the ash contains no organic matter.

In some embodiments, the ash further comprises calcium (Ca), potassium (K), magnesium (Mg), phosphorous (P), nitrogen (N), or sulfur(S), or any combination thereof.

In some embodiments, the ceramic composition comprises between about 50% to about 90% ash by weight of total dried algal biomass. In some embodiments, the ceramic composition comprises between about 50% to about 60%, about 60% to about 70%, about 70% to about 80%, or about 80% to about 90% ash by weight of total dried algal biomass. In some embodiments, the ceramic composition comprises between about 50% to about 70%, about 50% to about 80%, or between about 50% and 90% ash by weight of total dried algal biomass.

In some embodiments, the ceramic composition comprises from about 55% to about 85% ash by weight of total dried algal biomass. In some embodiments, the ceramic composition comprises from about 55% to about 65%, about 65% to about 75%, or about 75% to about 85% ash by weight of total dried algal biomass. In some embodiments, the ceramic composition comprises from about 55% to about 75% ash by weight of total dried algal biomass.

In some embodiments, the ceramic composition comprises from about 60% to about 80% ash by weight of total dried algal biomass. In some embodiments, the ceramic composition comprises from about 70% to about 80% ash by weight of total dried algal biomass. In some embodiments, the ceramic composition comprises from about 70% to about 71%, about 71% to about 72%, about 72% to about 73%, about 73% to about 74%, about 74% to about 75%, about 75% to about 76%, about 76% to about 77%, about 77% to about 78%, about 78% to about 79%, or about 79% to about 80% ash by weight of total dried algal biomass. In some embodiments, the ceramic composition comprises from about 70% to about 72%, about 70% to about 73%, about 70% to about 74%, about 70% to about 75%, about 70% to about 76%, about 70% to about 77%, about 70% to about 78%, or about 70% to about 79% ash by weight of total dried algal biomass. In some embodiments, the ceramic composition comprises from about 70% to about 72%, about 72% to about 74%, about 74% to about 76%, about 76% to about 78%, or about 78% to about 80% ash by weight of total dried algal biomass. In some embodiments, the ceramic composition comprises from about 70% to about 72%, about 70% to about 74%, about 70% to about 76%, or about 70% to about 78% ash by weight of total dried algal biomass.

In some embodiments, the ceramic composition comprises between about 25% to about 75% silica by weight of total ash, for example between about 25% to about 50%, about 45% to about 75%, about 40% to about 60%, or about 45% to about 55% silica by weight of total ash. In some embodiments, the ceramic composition comprises between about 25% and about 30% silica by weight of total ash, for example about 25%, about 26%, about 27%, about 28%, about 29%, or about 30% silica by weight of total ash. In some embodiments, the ceramic composition comprises between about 30% and about 35% silica by weight of total ash, for example about 31%, about 32%, about 33%, about 34%, or about 35% silica by weight of total ash. In some embodiments, the ceramic composition comprises between about 35% and about 40% silica by weight of total ash, for example about 35%, about 36%, about 37%, about 38%, about 39%, or about 40% silica by weight of total ash. In some embodiments, the ceramic composition comprises between about 40% and about 45% silica by weight of total ash, for example about 41%, about 42%, about 43%, about 44%, or about 45% silica by weight of total ash. In some embodiments, the ceramic composition comprises between about 45% and about 50% silica by weight of total ash, for example about 45%, about 46%, about 47%, about 48%, about 49%, or about 50% silica by weight of total ash. In some embodiments, the ceramic composition comprises between about 50% and about 55% silica by weight of total ash, for example about 51%, about 52%, about 53%, about 54%, or about 55% silica by weight of total ash. In some embodiments, the ceramic composition comprises between about 55% and about 60% silica by weight of total ash, for example about 55%, about 56%, about 57%, about 58%, about 59%, or about 60% silica by weight of total ash. In some embodiments, the ceramic composition comprises between about 60% and about 65% silica by weight of total ash, for example about 61%, about 62%, about 63%, about 64%, or about 65% silica by weight of total ash. In some embodiments, the ceramic composition comprises between about 65% and about 70% silica by weight of total ash, for example about 65%, about 66%, about 67%, about 68%, about 69%, or about 70% silica by weight of total ash. In some embodiments, the ceramic composition comprises between about 70% and about 75% silica by weight of total ash, for example about 71%, about 72%, about 73%, about 74%, or about 75% silica by weight of total ash. In some embodiments, the ceramic composition comprises about 51% silica by weight of total ash.

In some embodiments, the percent composition of calcium in obtained algal biomass by weight is between about 1.1% to about 1.3%. In some embodiments, the percent composition of calcium in obtained algal biomass by weight is between about 1.1% to about 1.15%, about 1.15% to about 1.2%, about 1.2% to about 1.25%, or about 1.25% to about 1.3%. In some embodiments, the percent composition of calcium in obtained algal biomass by weight is from about 1.1% to about 1.2%, about 1.1% to about 1.25%, or about 1.1% to about 1.3%. In some embodiments, the percent composition of calcium in obtained algal biomass by weight is between about 1.1% to about 1.12%, about 1.12% to about 1.14%, about 1.14% to about 1.16%, about 1.16% to about 1.18%, about 1.18% to about 1.20%, about 1.20% to about 1.22%, about 1.22% to about 1.24%, about 1.24 to about 1.26%, about 1.26% to about 1.28%, or about 1.28% to about 1.3%. In some embodiments, the percent composition of calcium in obtained algal biomass by weight is between about 1.1% to about 1.14%, about 1.1% to about 1.16%, about 1.1% to about 1.18%, about 1.1% to about 1.20%, about 1.1% to about 1.22%, about 1.1% to about 1.24%, about 1.1% to about 1.26%, or about 1.1% to about 1.28%.

In some embodiments, the percent composition of potassium in obtained algal biomass by weight is from 0.5% to 0.7%. In some embodiments, the percent composition of potassium in obtained algal biomass by weight is between about 0.5% to about 0.51%, 0.51% to 0.52%, 0.52% to 0.53%, 0.53% to 0.54%, 0.54% to 0.55%, 0.55% to 0.56%, 0.56% to 0.57% m 0.57% to 0.58%, 0.58% to 0.59%, 0.59% to 0.60%, 0.60% to 0.61%, 0.61% to 0.62%, 0.62% to 0.63%, 0.63% to 0.64%, 0.64% to 0.65%, 0.65% to 0.66%, 0.66% to 0.67%, 0.67% to 0.68%, 0.68% to 0.69%, or 0.69% to 0.70%. In some embodiments, the percent composition of potassium in obtained algal biomass by weight is from 0.5% to 0.52%, 0.5% to 0.53%, 0.5% to 0.54%, 0.5% to 0.55%, 0.5% to 0.56%, 0.5% to 0.57%, 0.5% to 0.58%, 0.5% to 0.59%, 0.5% to 0.60%, 0.5% to 0.61%, 0.5% to 0.62%, 0.5% to 0.63%, 0.5% to 0.64%, 0.5% to 0.65%, 0.5% to 0.66%, 0.5% to 0.67%, 0.5% to 0.68%, or 0.5% to 0.69%. In some embodiments, the percent composition of potassium in obtained algal biomass by weight is from 0.5% to 0.55%, 0.55% to 0.60%, 0.60% to 0.65%, or 0.65% to 0.7%. In some embodiments, the percent composition of potassium in obtained algal biomass by weight is from 0.5% to 0.65%.

In some embodiments, the percent composition of magnesium in obtained algal biomass by weight is from 0.9% to 1.1%. In some embodiments, the percent composition of magnesium in obtained algal biomass by weight is from 0.9% to 0.92%, 0.92% to 0.94%, 0.94% to 0.96%, 0.96% to 0.98%, 0.98% to 1.0%, 1.0% to 1.02%, 1.02% to 1.04%, 1.04% to 1.06%, 1.06% to 1.08%, or 1.08% to 1.1%. In some embodiments, the percent composition of magnesium in obtained algal biomass by weight is from 0.9% to 0.94%, 0.9% to 0.96%, 0.9% to 0.98%, 0.9% to 1.0%, 0.9% to 1.02%, 0.9% to 1.04%, 0.9% to 1.06%, or 0.9% to 1.08%. In some embodiments, the percent composition of magnesium in obtained algal biomass by weight is from 0.9% to 0.95%, 0.95% to 1.0%, 1.0% to 1.05%, or 1.05% to 1.10%. In some embodiments, the percent composition of magnesium in obtained algal biomass by weight is from 0.9% to 0.95%, or 0.9% to 1.05%.

In some embodiments, the percent composition of phosphorous in obtained algal biomass by weight is from 0.05% to 0.15%. In some embodiments, the percent composition of phosphorous in obtained algal biomass by weight is from 0.05% to 0.10% or 0.10% to 0.15%. In some embodiments, the present composition of phosphorous in obtained algal biomass by weight is from 0.05% to 0.07%, 0.07% to 0.09%, 0.11% to 0.13%, or 0.13% to 0.15%. In some embodiments, the present composition of phosphorous in obtained algal biomass by weight is from 0.05% to 0.09% or 0.05% to 0.13%.

In some embodiments, the percent composition of nitrogen in obtained algal biomass by weight is from 0.3% to 0.5%. In some embodiments, the percent composition of nitrogen in obtained algal biomass by weight is from 0.3% to 0.32%, 0.32% to 0.34%, 0.34% to 0.36%, 0.36% to 0.38%, 0.38% to 0.40%, 0.40% to 0.42%, 0.42% to 0.44%, 0.44% to 0.46%, 0.46% to 0.48%, or 0.48% to 0.50%. In some embodiments, the percent composition of nitrogen in obtained algal biomass by weight is from 0.3% to 0.34%, 0.3% to 0.36%, 0.3% to 0.38%, 0.3% to 0.40%, 0.3% to 0.42%, 0.3% to 0.44%, 0.3% to 0.46%, 0.3% to 0.48%, or 0.3% to 0.50%. In some embodiments, the percent composition of nitrogen in obtained algal biomass by weight is from 0.3% to 0.35%, 0.35% to 0.4%, 0.4% to 0.45%, or 0.45% to 0.5%. In some embodiments, the percent composition of nitrogen in obtained algal biomass by weight is from 0.3% to 0.4% or 0.4% to 0.45%.

In some embodiments, the percent composition of sulfur in obtained algal biomass by weight is from 1.0% to 1.2%. In some embodiments, the percent composition of sulfur in obtained algal biomass by weight is from 1.0% to 1.02%, 1.02% to 1.04%, 1.04% to 1.06%, 1.06% to 1.08%, 1.08% to 1.10%, 1.10% to 1.12%, 1.12% to 1.14%, 1.14% to 1.16%, 1.16% to 1.18%, or 1.18% to 1.20%. In some embodiments, the percent composition of sulfur in obtained algal biomass by weight is from 1.0% to 1.04%, 1.0% to 1.06%, 1.0% to 1.08%, 1.0% to 1.10%, 1.0% to 1.12%, 1.0% to 1.14%, 1.0% to 1.16%, or 1.0% to 1.18%. In some embodiments, the percent composition of sulfur in obtained algal biomass by weight is from 1.0% to 1.05%, 1.05% to 1.10%, 1.10% to 1.15%, or 1.15% to 1.20%. In some embodiments, the percent composition of sulfur in obtained algal biomass by weight is from 1.0% to 1.15%.

In some embodiments, the ceramic composition comprises aluminum, boron (B), cadmium (Cd), chromium (Cr), copper (Cu), iron (Fe), manganese (Mn), sodium (Na), nickel (Ni), lead (Pb), or zinc (Zn), or any combination thereof.

In some embodiments, the ceramic composition comprises between about 32000 ppm to about 43000 ppm of aluminum. In some embodiments, the ceramic composition comprises from 32000 ppm to 33000 ppm, 33000 ppm to 34000 ppm, 34000 ppm to 35000 ppm, 35000 ppm to 36000 ppm, 36000 ppm to 37000 ppm, 37000 ppm to 38000 ppm, 38000 ppm to 39000 ppm, 39000 to 40000 ppm, 40000 ppm to 41000 ppm, 41000 ppm to 42000 ppm, or 42000 ppm to 43000 ppm of aluminum. In specific examples, the ceramic composition comprises from 32000 ppm to 33000 ppm, 32000 ppm to 34000 ppm, 32000 ppm to 35000 ppm, 32000 ppm to 36000 ppm, 32000 ppm to 37000 ppm, 32000 ppm to 38000 ppm, 32000 ppm to 39000 ppm, 32000 to 40000 ppm, 32000 ppm to 41000 ppm, or 32000 ppm to 42000 ppm of aluminum.

In some embodiments, the ceramic composition comprises between about 32000 ppm to 32500 ppm, 32500 to 33000 ppm, 33000 ppm to 33500 ppm, 33500 ppm to 34000 ppm, 34000 ppm to 34500 ppm, 34500 ppm to 35000 ppm, 35000 ppm to 35500 ppm, 35500 to 36000 ppm, 36000 ppm to 36500 ppm, 36500 ppm to 37000 ppm, 37000 ppm to 37500 ppm, 37500 ppm to 38000 ppm, 38000 ppm to 38500 ppm, 38500 ppm to 39000 ppm, 39000 ppm to 39500 ppm, 39500 ppm to 40000 ppm, 40000 ppm to 40500 ppm, 40500 ppm to 41500 ppm, 41500 ppm to 42500 ppm, and 42500 ppm to 43000 ppm of aluminum. In some embodiments, the ceramic composition comprises between about 32000 ppm to 33500 ppm, 32000 ppm to 34500 ppm, 32000 ppm to 35500 ppm, 32000 ppm to 36500 ppm, 32000 ppm to 37500 ppm, 32000 ppm to 38500 ppm, 32000 ppm to 39500 ppm, 32000 ppm to 40500 ppm, 32000 ppm to 41500 ppm, 41500 ppm to 42500 ppm of aluminum.

In some embodiments, the ceramic composition comprises between about 64 ppm to 82 ppm of boron. In some embodiments, the ceramic composition comprises between about 64 ppm to 65 ppm, 65 ppm to 66 ppm, 66 ppm to 67 ppm, 67 ppm to 68 ppm, 68 ppm to 69 ppm, 69 ppm to 70 ppm, 70 ppm to 71 ppm, 71 ppm to 72 ppm, 72 ppm to 73 ppm, 73 ppm to 74 ppm, 74 ppm to 75 ppm, 75 ppm to 76 ppm, 76 ppm to 77 ppm, 77 ppm to 78 ppm, 78 ppm to 79 ppm, 79 ppm to 80 ppm, 80 ppm to 81 ppm, or 81 ppm to 82 ppm of boron. In some embodiments, the ceramic composition comprises between about 64 ppm to 66 ppm, 64 ppm to 67 ppm, 64 ppm to 68 ppm, 64 ppm to 69 ppm, 64 ppm to 70 ppm, 64 ppm to 71 ppm, 64 ppm to 72 ppm, 64 ppm to 73 ppm, 64 ppm to 74 ppm, 64 ppm to 75 ppm, 64 ppm to 76 ppm, 64 ppm to 77 ppm, 64 ppm to 78 ppm, 64 ppm to 79 ppm, 64 ppm to 80 ppm, or 64 ppm to 81 ppm of boron. In some embodiments, the ceramic composition comprises between about 64 ppm to 70 ppm, 70 ppm to 76 ppm, or 76 ppm to 82 ppm of boron. In some embodiments, the ceramic composition comprises between about 64 ppm to 76 ppm of boron. In some embodiments, the ceramic composition comprises between about 64 ppm to 67 ppm, 67 ppm to 70 ppm, 70 ppm to 73 ppm, 73 ppm to 76 ppm, 76 ppm to 79 ppm, or 79 ppm to 82 ppm of boron. In some embodiments, the ceramic composition comprises between about 64 ppm to 73 ppm or 64 ppm to 79 ppm of boron.

In some embodiments, the ceramic composition comprises between about 1.1 ppm to 1.5 ppm of cadmium. In some embodiments, the ceramic composition comprises between about 1.1 ppm to 1.2 ppm, 1.2 ppm to 1.3 ppm, 1.3 ppm to 1.4 ppm, or 1.4 ppm to 1.5 ppm of cadmium. In some embodiments, the ceramic composition comprises between about 1.1 ppm to 1.3 ppm or 1.1 ppm to 1.4 ppm of cadmium. In some embodiments, the ceramic composition comprises between about 1.1 ppm to 1.15 ppm, 1.15 ppm to 1.2 ppm, 1.2 ppm to 1.25 ppm, 1.25 ppm to 1.3 ppm, 1.3 ppm to 1.35 ppm, 1.35 ppm to 1.4 ppm, 1.4 ppm to 1.45 ppm, or 1.45 ppm to 1.5 ppm of cadmium. In some embodiments, the ceramic composition comprises between about 1.1 ppm to 1.25 ppm, 1.1 ppm to 1.35 ppm, or 1.1 ppm to 1.45 ppm of cadmium.

In some embodiments, the ceramic composition comprises between about 50 ppm to 60 ppm of chromium. In some embodiments, the ceramic composition comprises from 50 ppm to 52 ppm, 52 ppm to 54 ppm, 54 ppm to 56 ppm, 56 ppm to 58 ppm, or 58 ppm to 60 ppm of chromium. In some embodiments, the ceramic composition comprises between about 50 ppm to 54 ppm, 50 ppm to 56 ppm, or 50 ppm to 58 ppm of chromium. In some embodiments, the ceramic composition comprises between about 50 ppm to 55 ppm, or 55 ppm to 60 ppm of chromium. In some embodiments, the ceramic composition comprises between about 50 ppm to 51 ppm, 51 ppm to 53 ppm, 53 ppm to 54 ppm, 54 ppm to 55 ppm, 55 ppm to 56 ppm, 56 ppm to 57 ppm, 57 ppm to 58 ppm, 58 ppm to 59 ppm, to 59 to 60 ppm of chromium. In some embodiments, the ceramic composition comprises between about 50 ppm to 53 ppm, 50 ppm to 55 ppm, 50 ppm to 57 ppm, or 50 ppm to 59 ppm of chromium.

In some embodiments, the ceramic composition comprises between about 12.5 ppm to 13.7 ppm of copper. In some embodiments, the ceramic composition comprises between about 12.5 ppm to 12.7 ppm, 12.7 ppm to 12.9 ppm, 12.9 ppm to 13.1 ppm, 13.1 ppm to 13.3 ppm, 13.3 ppm to 13.5 ppm, or 13.5 ppm to 13.7 ppm of copper. In some embodiments, the ceramic composition comprises between about 12.5 ppm to 12.9 ppm, 12.5 ppm to 13.1 ppm, 12.5 ppm to 13.3 ppm, or 12.5 ppm to 13.5 ppm of copper. In some embodiments, the ceramic composition comprises between about 12.5 ppm to 12.8 ppm, 12.5 ppm to 13.1 ppm, 12.5 ppm to 13.4 ppm, or 12.5 ppm to 13.7 ppm of copper. In some embodiments, the ceramic composition comprises between about 12.5 ppm to 13.1 ppm or 12.5 ppm to 13.4 ppm of copper.

In some embodiments, the ceramic composition comprises between about 27850 ppm to 30500 ppm of iron. In some embodiments, the ceramic composition comprises between about 27850 ppm to 28350 ppm, 28350 ppm to 28850 ppm, 28850 ppm to 29350 ppm, 29350 ppm to 29850 ppm, 29850 ppm to 30350 ppm, or 30350 ppm to 30500 pm of iron. In some embodiments, the ceramic composition comprises between about 27850 ppm to 28850 ppm, 27850 ppm to 29350 ppm, 27850 ppm to 29850 ppm, or 27850 ppm to 30350 ppm of iron.

In some embodiments, the ceramic composition comprises between about 830 ppm to 870 ppm of manganese. In some embodiments, the ceramic composition comprises between about 830 ppm to 835 ppm, 835 ppm to 840 ppm, 840 ppm to 845 ppm, 845 ppm to 850 ppm, 850 ppm to 855 ppm, 855 ppm to 860 ppm, 860 ppm to 865 ppm, or 865 ppm to 870 ppm of manganese. In some embodiments, the ceramic composition comprises between about 830 ppm to 840 ppm, 830 ppm to 845 ppm, 830 ppm to 850 ppm, 830 ppm to 855 ppm, 830 ppm to 860 ppm, or 830 ppm to 865 ppm of manganese. In some embodiments, the ceramic composition comprises between about 830 ppm to 832 ppm, 832 ppm to 834 ppm, 834 ppm to 836 ppm, 836 ppm to 838 ppm, 838 ppm to 840 ppm, 840 ppm to 842 ppm, 842 ppm to 844 ppm, 844 ppm to 846 ppm, 846 ppm to 848 ppm, or 848 ppm to 850 ppm of manganese. In some embodiments, the ceramic composition comprises between about 830 ppm to 832 ppm, 830 ppm to 834 ppm, 830 ppm to 836 ppm, 830 ppm to 838 ppm, 830 ppm to 840 ppm, 830 ppm to 842 ppm, 830 ppm to 844 ppm, 830 ppm to 846 ppm, or 830 ppm to 848 ppm of manganese.

In some embodiments, the ceramic composition comprises between about 30000 ppm to 40000 ppm of sodium. In some embodiments, the ceramic composition comprises between about 30000 ppm to 31000 ppm, 31000 ppm to 32000 ppm, 32000 ppm to 33000 ppm, 33000 ppm to 34000 ppm, 34000 ppm to 35000 ppm, 35000 ppm to 36000 ppm, 36000 ppm to 37000 ppm, 37000 ppm to 38000 ppm, 38000 ppm to 39000 ppm, or 39000 ppm to 40000 ppm of sodium. In some embodiments, the ceramic composition comprises between about 30000 ppm to 32000 ppm, 30000 ppm to 33000 ppm, 30000 ppm to 34000 ppm, 30000 ppm to 35000 ppm, 30000 ppm to 36000 ppm, 30000 ppm to 37000 ppm, 30000 ppm to 38000 ppm, or 30000 ppm to 39000 ppm of sodium. In some embodiments, the ceramic composition comprises between about 30000 ppm to 32500 ppm, 32500 ppm to 35000 ppm, 35000 ppm to 37500 ppm, or 37500 ppm to 40000 ppm of sodium. In some embodiments, the ceramic composition comprises between about 30000 ppm to 32500 ppm or 30000 to 37500 ppm of sodium.

In some embodiments, the ceramic composition comprises between about 13 ppm to 15.5 ppm of nickel. In some embodiments, the ceramic composition comprises between about 13 ppm to 13.1 ppm, 13.1 ppm to 13.2 ppm, 13.2 ppm to 13.3 ppm, 13.3 ppm to 13.4 ppm, 13.4 ppm to 13.5 ppm, 13.5 ppm to 13.6 ppm, 13.6 ppm to 13.7 ppm, 13.7 ppm to 13.8 ppm, 13.8 ppm to 13.9 ppm, 13.9 ppm to 14.0 ppm, 14.0 ppm to 14.1 ppm, 14.1 ppm to 14.2 ppm, 14.2 ppm to 14.3 ppm, 14.3 ppm to 14.4 ppm, 14.4 ppm to 14.5 ppm, 14.5 ppm to 14.6 ppm, 14.6 ppm to 14.7 ppm, 14.7 ppm to 14.8 ppm, 14.8 ppm to 14.9 ppm, 14.9 ppm to 15.0 ppm, 15.0 ppm to 15.1 ppm, 15.1 ppm, 15.2 ppm, 15.2 ppm to 15.3 ppm, 15.3 ppm to 15.4 ppm, or 15.4 ppm to 15.5 ppm of nickel. In some embodiments, the ceramic composition comprises between about 13 ppm to 13.2 ppm, 13 ppm to 13.3 ppm, 13 ppm to 13.4 ppm, 13 ppm to 13.5 ppm, 13 ppm to 13.6 ppm, 13 ppm to 13.7 ppm, 13 ppm to 13.8 ppm, 13 ppm to 13.9 ppm, 13 ppm to 14.0 ppm, 14 ppm to 14.1 ppm, 14 ppm to 14.2 ppm, 14 ppm to 14.3 ppm, 14 ppm to 14.4 ppm, 14 ppm to 14.5 ppm, 14 ppm to 14.6 ppm, 14 ppm to 14.7 ppm, 14 ppm to 14.8 ppm, 14 ppm to 14.9 ppm, 14 ppm to 15.0 ppm, 13 ppm to 15.1 ppm, 13 ppm to 15.2 ppm, 13 ppm to 15.3 ppm, or 13 ppm to 15.4 ppm of nickel. In some embodiments, the ceramic composition comprises between about 13 ppm to 13.5 ppm, 13.5 ppm to 14 ppm, 14 ppm to 14.5 ppm, 14.5 ppm to 15 ppm, or 15 ppm to 15.5 ppm of nickel.

In some embodiments, the ceramic composition comprises between about 37.5 ppm to 47.5 ppm of lead. In some embodiments, the ceramic composition comprises between about 37.5 ppm to 38 ppm, 38 ppm to 38.5 ppm, 38.5 ppm to 39 ppm, 39 ppm to 39.5 ppm, 39.5 ppm to 40 ppm, 40 ppm to 40.5 ppm, 40.5 ppm to 41 ppm, 41 ppm to 41.5 ppm, 41.5 ppm to 42 ppm, 42 ppm to 42.5 ppm, 42.5 ppm to 43 ppm, 43 ppm to 43.5 ppm, 43.5 ppm to 44 ppm, 44 ppm to 44.5 ppm, 44.5 ppm to 45 ppm, 45 ppm to 45.5 ppm, 45.5 ppm to 46 ppm, 46 ppm to 46.5 ppm, 46.5 ppm to 47 ppm, or 47 ppm to 47.5 ppm of lead. In some embodiments, the ceramic composition comprises between about 37.5 ppm to 38 ppm, 37.5 ppm to 38.5 ppm, 37.5 ppm to 39 ppm, 37.5 ppm to 39.5 ppm, 37.5 ppm to 40 ppm, 37.5 ppm to 40.5 ppm, 37.5 ppm to 41 ppm, 37.5 ppm to 41.5 ppm, 37.5 ppm to 42 ppm, 37.5 ppm to 42.5 ppm, 37.5 ppm to 43 ppm, 37.5 ppm to 43.5 ppm, 37.5 ppm to 44 ppm, 37.5 ppm to 44.5 ppm, 37.5 ppm to 45 ppm, 37.5 ppm to 45.5 ppm, 37.5 ppm to 46 ppm, 37.5 ppm to 46.5 ppm, or 37.5 ppm to 47 ppm of lead. In some embodiments, the ceramic composition comprises between about 37.5 ppm to 40 ppm, 40 ppm to 42.5 ppm, 42.5 ppm to 45 ppm, or 45 ppm to 47.5 ppm of lead. In some embodiments, the ceramic composition comprises between about 42.5 ppm to 47.5 ppm of lead.

In some embodiments, the ceramic composition comprises between about 74 ppm to 90 ppm of zinc. In some embodiments, the ceramic composition comprises between about 74 ppm to 76 ppm, 76 ppm to 78 ppm, 78 ppm to 80 ppm, 80 ppm to 82 ppm, 82 ppm to 84 ppm, 84 ppm to 86 ppm, 86 ppm to 88 ppm, or 88 ppm to 90 ppm of zinc. In some embodiments, the ceramic composition comprises between about 74 ppm to 78 ppm, 74 ppm to 80 ppm, 74 ppm to 82 ppm, 74 ppm to 84 ppm, 74 ppm to 86 ppm, or 74 ppm to 88 ppm of zinc. In some embodiments, the ceramic composition comprises between about 74 ppm to 78 ppm, 78 ppm to 82 ppm, 82 ppm to 86 ppm, or 86 ppm to 90 ppm of zinc.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### Embodiments

1. A method of making a clay comprising obtaining algal biomass and processing the algal biomass.
2. The method of embodiment 1, wherein processing the algal biomass comprises filtering the algal biomass.
3. The method of embodiment 1, wherein filtering comprises pushing the algal biomass through a mesh layer.
4. The method of any one of embodiments 1-3, wherein processing the algal biomass comprises removing a particulate from the algal biomass.
5. The method of any one of embodiments 1-4, wherein processing the algal biomass comprises homogenizing a particulate from the algal biomass.
6. The method of any one of embodiments 4-5, wherein the particulate comprises shells.
7. The method of any one of embodiments 3-6, wherein the mesh layer comprises a metal screen or cheesecloth.
8. The method of any one of embodiments 1-7, wherein processing the algal biomass further comprises powderizing the algal biomass, wherein powderizing the algal biomass comprises drying the algal biomass to result in dried algal biomass and grinding the dried algal biomass.
9. The method of embodiment 8, wherein drying the algal biomass comprises air drying the algal biomass, heating the algal biomass in an oven, or any combination thereof.
10. The method of embodiment 9, wherein the oven is at from 90° C. to 120° C.
11. The method of any one of embodiments 9-10, wherein the algal biomass is heated in the oven for 68 hours to 76 hours.
12. The method of any one of embodiments 8-11, wherein grinding the algal biomass comprises grinding the algal biomass with a mortar and pestle, a blender, or a combination thereof.
13. The method of any one of embodiments 8-12, wherein the method further comprises combining the dried algal biomass with a water mixture.
14. A method of making a ceramic comprising the method of any one of embodiments 1-13 and heating the clay to from 1100° F. to 2700° F.
15. The method of embodiment 14, wherein the clay is heated to from 1700° F. to 2100° F.
16. The method of embodiment 14, wherein the clay is heated to from 2100° F. to 2300° F.
17. The method of embodiment 14, wherein the clay is heated to from 2300° F. to 2700° F.
18. The method of any one of embodiments 14-17, wherein the method further comprises shaping the clay into a desired shape.
19. The method of any one of embodiments 14-18, wherein the clay is heated until it is porous and has a reduced solubility in water.
20. A method of reef restoration comprising making a sculpture suitable for reef restoration according to the method of any one of embodiments 14-19, and placing the sculpture in a body of water.
21. The method of embodiment 20, wherein the sculpture suitable for reef restoration comprises a three-dimensional (3D) frame, 3D star, pyramid, cube, or sphere.
22. A ceramic composition comprising ash, wherein the ash comprises silica and is derived from algal biomass and wherein the ceramic composition is porous and has a reduced solubility in water.
23. The ceramic composition of embodiment 22, wherein the ash further comprises calcium, potassium, magnesium, phosphorous, nitrogen, or sulfur, or any combination thereof.
24. The ceramic composition of any one of embodiments 22-23, wherein the ceramic composition comprises from 50% to 90% by weight of silica.
25. The ceramic composition of any one of embodiments 22-24, wherein the ceramic composition comprises from 55% to 85% by weight of silica.
26. The ceramic composition of any one of embodiments 22-25, wherein the ceramic composition comprises from 60% to 80% by weight of silica.
27. The ceramic composition of any one of embodiments 22-26, wherein the ceramic composition comprises from 70% to 80% by weight of silica.
28. The ceramic composition of any one of embodiments 23-27, wherein the percent composition by weight of calcium is from 1.1% to 1.3%.
29. The ceramic composition of any one of embodiments 23-28, wherein the percent composition by weight of potassium is from 0.5% to 0.7%.
30. The ceramic composition of any one of embodiments 23-29, wherein the percent composition by weight of magnesium is from 0.9% to 1.1%.
31. The ceramic composition of any one of embodiments 23-30, wherein the percent composition by weight of phosphorous is from 0.05% to 0.15%.
32. The ceramic composition of any one of embodiments 23-31, wherein the percent composition by weight of nitrogen is from 0.3% to 0.5%.
33. The ceramic composition of any one of embodiments 23-32, wherein the percent composition by weight of sulfur is from 1.0% to 1.2%.
34. The ceramic composition of any one of embodiments 22-33, wherein the ceramic composition comprises aluminum, boron, cadmium, chromium, copper, iron, manganese, sodium, nickel, lead, or zinc, or any combination thereof.
35. The ceramic composition of embodiment 34, wherein the ceramic composition comprises from 32000 ppm to 43000 ppm of aluminum.
36. The ceramic composition of any one of embodiments 34-35, wherein the ceramic composition comprises from 64 ppm to 82 ppm of boron.
37. The ceramic composition of any one of embodiments 34-36, wherein the ceramic composition comprises from 1.1 ppm to 1.5 ppm of cadmium.
38. The ceramic composition of any one of embodiments 34-37, wherein the ceramic composition comprises from 50 ppm to 60 ppm of chromium.
39. The ceramic composition of any one of embodiments 34-38, wherein the ceramic composition comprises from 12.5 ppm to 13.7 ppm of copper.
40. The ceramic composition of any one of embodiments 34-39, wherein the ceramic composition comprises from 27850 ppm to 30500 ppm of iron.
41. The ceramic composition of any one of embodiments 34-40, wherein the ceramic composition comprises from 830 ppm to 870 ppm of manganese.
42. The ceramic composition of any one of embodiments 34-41, wherein the ceramic composition comprises from 30000 ppm to 40000 ppm of sodium.
43. The ceramic composition of any one of embodiments 34-42, wherein the ceramic composition comprises from 13 ppm to 15.5 ppm of nickel.
44. The ceramic composition of any one of embodiments 34-43, wherein the ceramic composition comprises from 37.5 ppm to 47.5 ppm of lead.
45. The ceramic composition of any one of embodiments 34-44, wherein the ceramic composition comprises from 74 ppm to 90 ppm of zinc.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Exploring the Intersection of Art, Science, and Marine Conservation Using Algal Biomass Waste

### Introduction

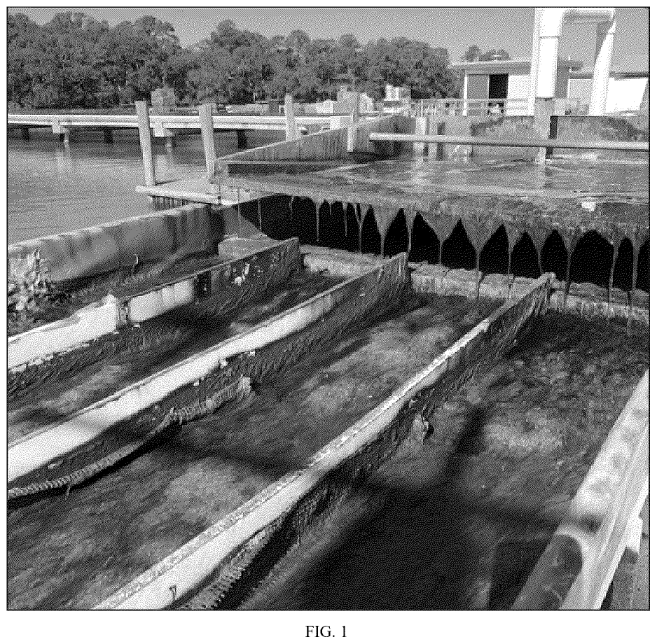

Algal blooms occur in larger bodies of water, such as ponds, lakes, rivers, and estuaries, when excessive nutrients such as nitrogen and phosphorus build up in aquatic ecosystems. While these elements are essential for primary producers such as plants and algae, an influx of this nutrient pollution, known as eutrophication, can be problematic. Eutrophication has been linked to the occurrence of harmful algal blooms in coastal regions where wastewater and agricultural runoff from land empties into nearshore environments. Harmful algal blooms can lead to degraded water quality, depletion of oxygen levels, and biodiversity loss. Algal turf scrubber (ATS) technology is used to remedy eutrophic wetlands when a single, non-point source of the pollution cannot be located. Large-scale ATS units have been installed throughout wetlands of South Florida to remediate waters of Lake Okeechobee and the Everglades. An ATS system works by continuously pumping water over an inclined runway where algae and other organisms can colonize. The lawn or “turf” of periphyton (FIG. 1) serves as a biological filter as nutrients are cleaned from the water and taken up by the living matrix of biomass.

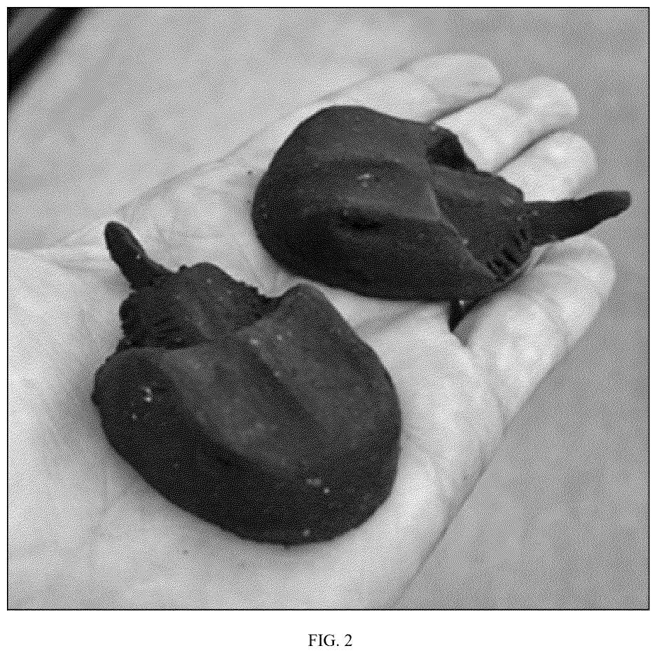

Regardless of the scale and size of the ATS system, algal productivity in nutrient-rich waters is excessive, and the resulting lawn must be periodically removed to allow new biomass to continue nutrient uptake. Disposal or reuse of this algal biomass can be problematic. For large-scale ATS systems, harvested biomass can be converted into animal feedstock, fertilizer, or biofuel. Yet, the relatively high amount of inorganic ash in harvested algal turf poses a challenge for biorefinery and limits its secondary use. The added salt in algal biomass from marine ATS systems further limits its secondary use and, instead of being recycled, is sent to landfills where it is added to the accumulation of discarded trash. Discussed herein is the methodology to utilize algal biomass waste as a clay body for ceramic products (FIG. 2).

Converting algal biomass into ceramics recycles algal biomass waste from ATS systems by converting it into ceramic products, reduces the demand for finite industrially mined clay bodies and materials, and provides a potential substrate for reef-dwelling marine organisms such as oysters and corals.

Small and large-scale ATS and other periphyton nutrient removal systems are currently in operation in the U.S., so an abundance of waste algal biomass can be kept out of landfills by reclaiming its mineral-rich content while simultaneously serving as an alternative source of mined clays. Because periphyton acts as a natural aquatic filter, trace minerals captured from the water are incorporated by living algae and stored in their biomass. Bioaccumulation of elements in periphytic growth was explored as a more sustainable and renewable alternative to extracting minerals from finite clay mines.

Ceramics made from algal biomass are aesthetically and structurally similar to that of terracotta clay sculptures and can similarly have a variety of uses. Using ceramics made from 100% algal biomass to serve as an alternative substrate for reef restoration is especially appealing as it represents a return to its marine source. Although natural oyster shells are the preferred substrate in constructing oyster reef habitat, the demand for shell exceeds the availability so alternative substrates are utilized. Concrete is the most commonly-used reef shell substitute, but others include porcelain, limestone, and granite. Ceramic reefs constructed from algal biomass provide an alternative solution that may yield the same physical results.

Algal Turf Scrubbers (ATS) are designed to remediate polluted waters where wastewater and agricultural runoff have caused eutrophication, and the non-point source of excess nutrients cannot be determined. These ATS systems improve water quality by encouraging algal growth on flow-way surfaces rather than forming harmful blooms in open waters. Excessive nutrients from the water accumulate in the flow-way's lawn of algae, and unless the algal biomass is repurposed, it is discarded in landfills as waste.

Discussed herein is a methodology to utilize waste algal biomass as a source of clay. Raw algal waste contains minerals which can be used as a sustainable and more environmentally-friendly alternative to industrially-mined clays. When algae-based clay sculptures are kiln fired, they resemble terracotta brick in their color, durability, and porosity.

### How Algae is Similar to Clay

Clay is composed of silica, aluminum, calcium, iron and other materials which, once fired to a high enough temperature, become ceramics that no longer dissolve in water. These same minerals are also found in ATS algal biomass (Tables 1 and 2). Regardless of the water source, the bulk of collected biomass will likely consist of diatoms, cyanobacteria and green algae though environmental factors such as water temperature and sunlight will influence the relative abundance of these primary producers. Once the organic material is heated and all carbon is burned off in the ceramic firing process, only inorganic minerals remain. Like other organic materials such as wood and straw, algal biomass will produce inorganic ash residue after heating. Ironically, while ash limits the recycling potential of ATS waste, that component contributes to the viability of its use for ceramic sculptures. The ash from harvested biomass from an ATS system is relatively high (˜75 wt %) with nearly half of that total weight coming from silica. In addition to the silica found in the cell walls of diatoms, the gelatinous mucilage of periphytic algae will trap inorganic particulates from suspended silt adding to the clay's ash content. This silica-based ash in the matrix of periphytic algae provides the unique potential for use as clay for ceramics by promoting porosity, water absorption, and strength.

TABLE 1
Percent composition of mineral elements (Ca—Calcium,
K—Potassium, Mg—Magnesium, P—Phosphorus,
N—Nitrogen, S—Sulfur) from ATS algal biomass
from four flow-way samples from scrubbers at the Skidaway River.

Percent Composition

| | Ca | K | Mg | P | N | S |
|---|---|---|---|---|---|---|
| Mean | 1.2 | 0.6 | 1.0 | 0.1 | 0.4 | 1.1 |
| Sd | 0.04 | 0.03 | 0.07 | 0.00 | 0.01 | 0.05 |

### Sources of Algae

Algal biomass for clay use can be sourced from any marine or brackish waterway. Clay from freshwater algae can be used but we have found that marine biomass produces better ceramics. Marine ATS has higher ash from an abundance of diatoms and sediment-trapping mucilage of marine algae. In addition to using algal biomass from an ATS system at the Skidaway River in Savannah, Georgia, marine algae was collected from two other sources to determine if different types of periphytic growth could be utilized. Algal scum growing at the waterline on the walls of a marine aquaponics tank were collected and biofilm from the slick part of a concrete boat ramp was scraped at low tide. For all three sources, abrasive barnacle and mollusk shells were removed, and the raw, unprocessed algal biomass poured into resealable plastic bags. This bulk storage of algae was frozen (−18° C.) until ready to defrost and use as a source of clay.

TABLE 2
Quantity (parts per million) of mineral elements (Al—Aluminum, B—Boron,
Cd—Cadmium, Cr—Chromium, Cu—Copper, Fe—Iron, Mn—Manganese,
Na—Sodium, Ni—Nickel, Pb—Lead, Zn—Zinc) from four samples
collected from four algal turf scrubber flow-ways at the Skidaway River in Savannah Ga.

| | Parts Per Million (PPM) | | | | | | | | | | |
|---|---|---|---|---|---|---|---|---|---|---|---|
| | Al | B | Cd | Cr | Cu | Fe | Mn | Na | Ni | Pb | Zn |
| Mean | 37681.8 | 73.0 | 1.3 | 54.4 | 13.1 | 28100.0 | 849.5 | 35533.0 | 14.3 | 42.6 | 82.7 |
| SD | 5411.7 | 8.8 | 0.2 | 4.5 | 0.6 | 2008.2 | 17.7 | 4387.9 | 1.01 | 4.47 | 7.72 |

Processing Algae into Clay

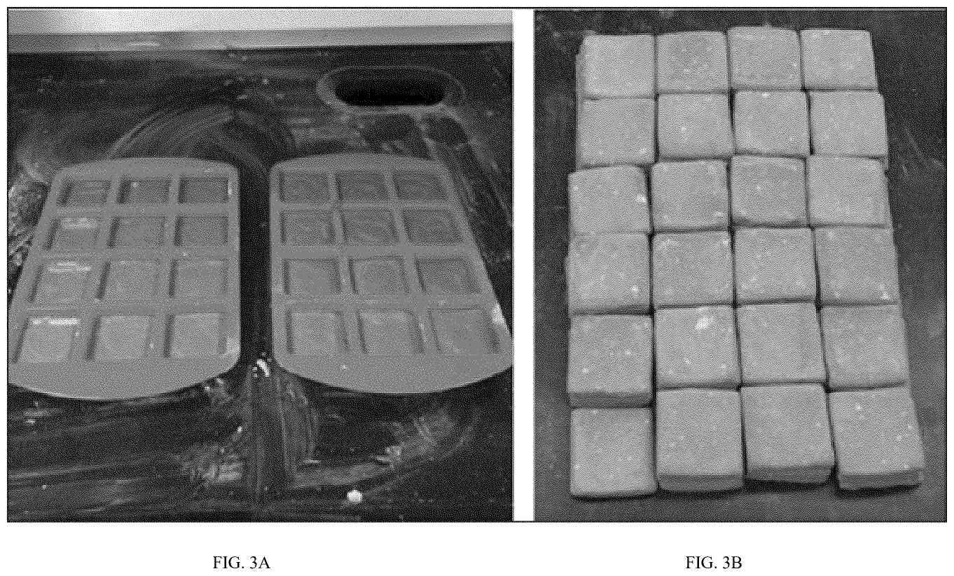

Unprocessed, raw ATS biomass will have a consistency of liquified clay, known as slip, Algal slip can be poured into plaster or silicone molds and allowed to air dry (FIGS. 3A-3B). Using this method, ceramic products will have a standardized shape and can be replicated with minimal processing. However, by using unprocessed algal slip, the finished ceramic products will likely have remnants of shells and other particulates that will surface during firing and will appear as white specks (FIGS. 3A-3B). To create a clay body similar to what is used in a regular ceramic practice with commercially available clays, the slurry must be further processed. To create a clay with a smooth consistency, the raw algal slip can be filtered through a mesh such as a metal screen colander or a cheesecloth to remove shell particles. The slurry can also be ground in a common household blender to homogenize the algae while reducing any remaining shell fragments into smaller, non-abrasive particles. This wet slurry can be poured onto plaster slabs or left in the sun to remove excess moisture to get a workable clay body.

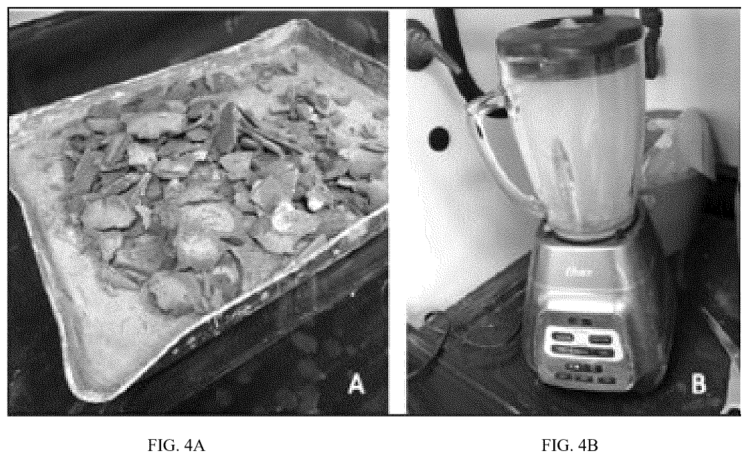

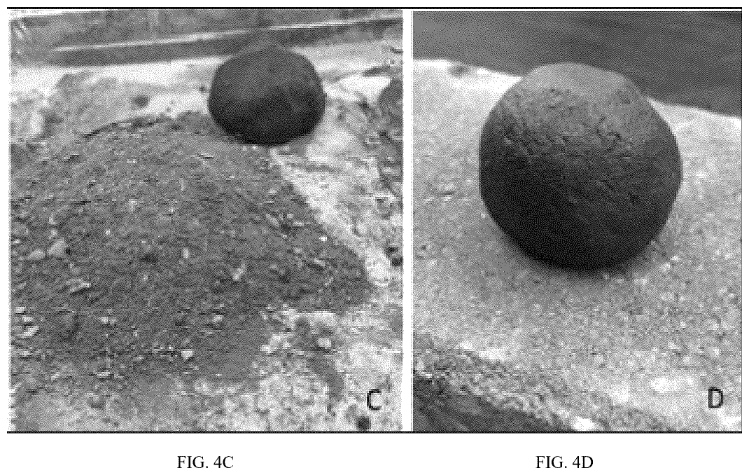

For long-term dry storage, the algal slurry was processed into a dried powder until ready to rehydrate and use as clay (FIGS. 4A-4D). To powderize the biomass, the algae was poured into aluminum cooking trays and allowed to either air dry over several days or heated in an oven at 105° C. for 72 hours. Dried algae can be ground manually with a mortar and pestle, but a blender was used to turn the biomass into fine powder. Once fully powderized, the collection of dried algae was stored at room temperature in sealed plastic bags or containers and reconstituted with water until a moldable consistency was reached. Because algae-based clay largely consists of organic material, it usually has an odor similar to a coastal saltmarsh. If handling algae-based clay is a concern, general safety precautions used when working with commercially available clays can be followed. As such, natural clays purchased in a store likewise contain organic living components such as fungi, mold, and bacteria. Similarly, when working with any dry ceramic product such as commercial ball clay or fireclay, a respirator such as an N-95 mask should, likewise, be worn when working with powderize algae. Although not necessary, people working with these dry materials can wear additional personal protective equipment like gloves and eye protection.

### Producing Finished Sculptures

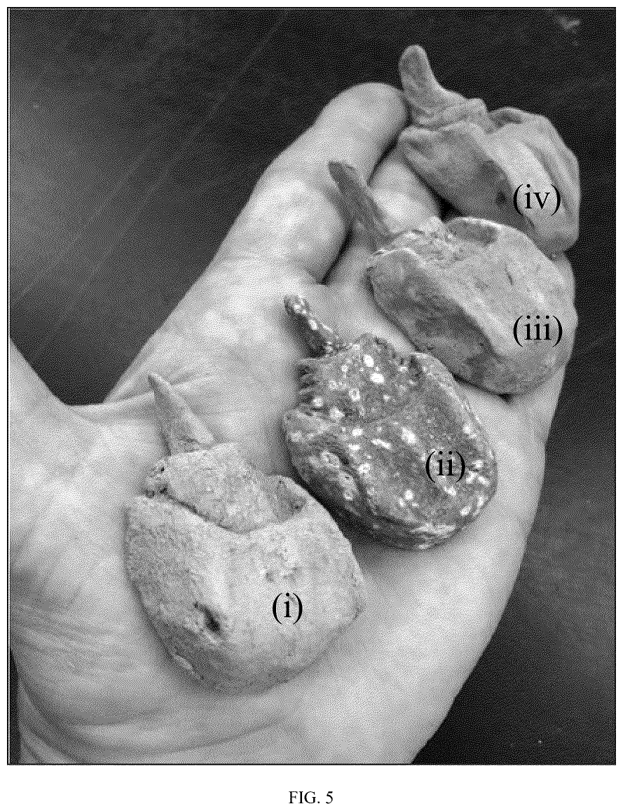

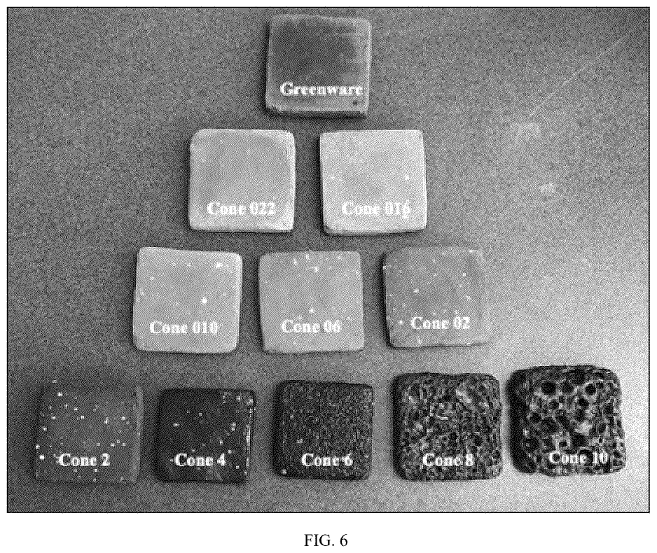

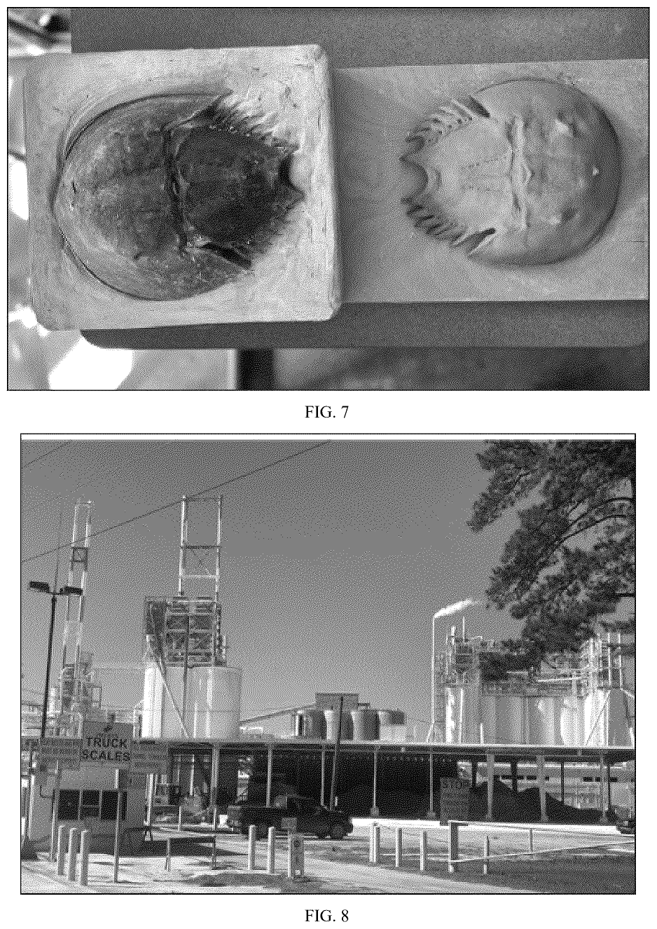

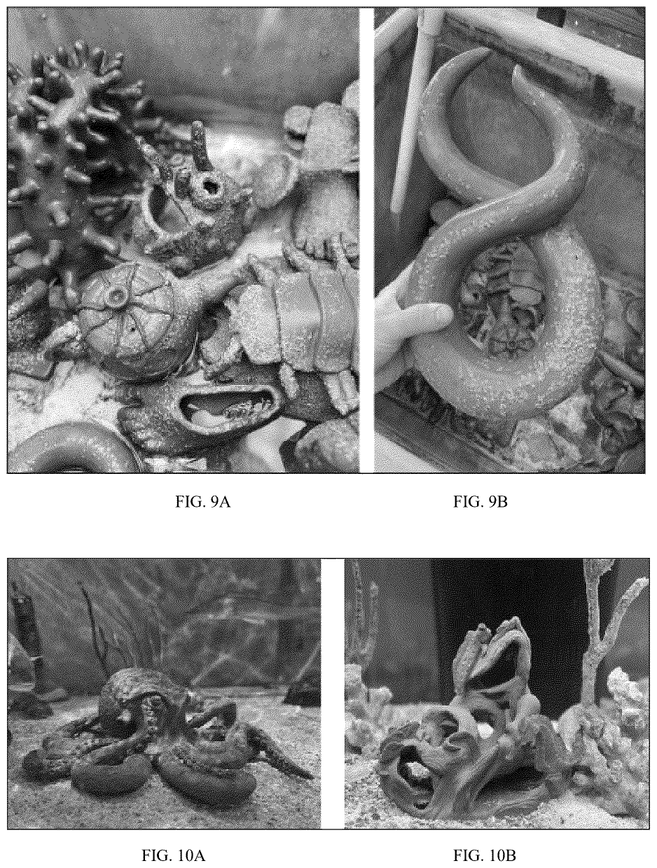

Sculptures made from algal biomass can be air dried and will stay preserved indefinitely as greenware (FIG. 5) unless rehydrated. When greenware sculptures were heated to at least 1100° F./593° C. (cone 022), the ceramic products were porous but no longer dissolve in water. Desktop electric kilns are a relatively affordable option and are commonly purchased for at-home use by novice and experienced artists. Alternative firing methods such as pit or barrel firings can be used to reach high enough temperatures. All of our sculptures were fired in an electric oxidizing kiln at temperatures up to a bisque 1830° F./999° C. (cone 06). Although there was some variation in the general appearance of the finished products (FIGS. 5, 9A-9B, 10A-10B), sculptures made from algae from the three different sources (i.e., edges of a marine tank, ATS flow-way and concrete boat dock) resulted in brick-like, low-fire ceramics similar to terracotta. By incrementally elevating firing temperatures up to glazing levels, the color of the ceramic products changed from red to a rich brown color (FIG. 6). For larger projects that required an abundance of clay, equal amounts of algae clay was mixed with commercially purchased Lizella Georgia clay (FIG. 7).

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A method of making a clay comprising:
(i) obtaining algal biomass; and
(ii) processing the algal biomass.

2. The method of claim 1, wherein processing the algal biomass comprises filtering the algal biomass, removing one or more particulates from the algal biomass, homogenizing the one or more particulates from the algal biomass, powderizing the algal biomass, or any combination thereof.

3. The method of claim 2, wherein filtering the algal biomass comprises pushing the algal biomass through a mesh layer.

4. The method of claim 3, wherein the mesh layer comprises a metal screen or cheesecloth.

5. The method of claim 2, wherein powderizing the algal biomass comprises drying the algal biomass to provide a dried algal biomass and grinding the dried algal biomass.

6. The method of claim 5, wherein drying the algal biomass comprises air drying the algal biomass, heating the algal biomass in an oven, or any combination thereof.

7. The method of claim 6, wherein the oven is at a temperature between about 90° C. to about 120° C., and wherein the algal biomass is heated in the oven for between about 68 hours to about 76 hours.

8. The method of claim 5, wherein grinding the algal biomass comprises grinding the algal biomass with a mortar and pestle, a blender, or a combination thereof.

9. The method of claim 1, further comprising combining the dried algal biomass with a water mixture.

10. The method of claim 1, further comprising shaping the algal biomass into a clay body.

11. A method of making a ceramic, comprising:
(i) obtaining algal biomass;
(ii) processing the algal biomass;
(iii) shaping the algal biomass to provide a clay body; and
(iv) heating the clay body at a temperature between about 1100° F. to about 2700° F.

12. The method of claim 11, wherein the clay body is heated at a temperature between about 1700° F. to about 2100° F.

13. The method of claim 11, wherein the clay body is heated at a temperature between about 2100° F. to about 2300° F.

14. The method of claim 11, wherein the clay body is heated at a temperature between about 2300° F. to about 2700° F.

15. The method of claim 11, wherein the clay body is heated until it is porous and has a reduced solubility in water.

16. A method of reef restoration, comprising:
(i) obtaining algal biomass;
(ii) processing the algal biomass;
(iii) shaping the algal biomass to provide a clay body;
(iv) heating the clay body at a temperature between about 1100° F. to about 2700° F. to provide a ceramic sculpture; and
(v) placing the ceramic sculpture in a body of water.

17. A ceramic composition, comprising ash derived from algal biomass, wherein the ash comprises silica, wherein the ceramic composition is porous, and wherein the ceramic composition has a reduced solubility in water relative to the clay body prior to heating.

18. The ceramic composition of claim 17, comprising between about 50% to about 90% ash by weight of total dried algal biomass.

19. The ceramic composition of claim 17, comprising between about 25% to about 75% silica by weight of total ash.

20. The ceramic composition of claim 17, wherein the ceramic composition further comprises calcium, potassium, magnesium, phosphorous, nitrogen, or sulfur, or any combination thereof.

21. The ceramic composition of claim 20, wherein the percent composition of calcium in obtained algal biomass by weight is between about 1.1% to about 1.3%;
wherein the percent composition of potassium in obtained algal biomass by weight is between about 0.5% to about 0.7%;
wherein the percent composition of magnesium in obtained algal biomass by weight is between about 0.9% to about 1.1%;
wherein the percent composition of phosphorous in obtained algal biomass by weight is between about 0.05% to about 0.15%;
wherein the percent composition of nitrogen in obtained algal biomass by weight is between about 0.3% to about 0.5%; and/or
wherein the percent composition of sulfur in obtained algal biomass by weight is between about 1.0% to about 1.2%.

22. The ceramic composition of claim 20, wherein the ceramic composition further comprises aluminum, boron, cadmium, chromium, cooper, iron, manganese, sodium, nickel, lead, or zinc, or any combination thereof.

23. The ceramic composition of claim 22, wherein the ceramic composition comprises between about 32000 ppm to about 43000 ppm of aluminum;
wherein the ceramic composition comprises between about 64 ppm to about 82 ppm of boron;
wherein the ceramic composition comprises between about 1.1 ppm to about 1.5 ppm of cadmium;
wherein the ceramic composition comprises between about 50 ppm to about 60 ppm of chromium;
wherein the ceramic composition comprises between about 12.5 ppm to about 13.7 ppm of copper;
wherein the ceramic composition comprises between about 27850 ppm to about 30500 ppm of iron;
wherein the ceramic composition comprises between about 830 ppm to about 870 ppm of manganese;
wherein the ceramic composition comprises between about 30000 ppm to about 40000 ppm of sodium;
wherein the ceramic composition comprises between about 13 ppm to about 15.5 ppm of nickel;
wherein the ceramic composition comprises between about 37.5 ppm to about 47.5 ppm of lead; and/or
wherein the ceramic composition comprises between about 74 ppm to about 90 ppm of zinc.
